(19) United States
(12) Patent Application Publication
(10) Pub. No.: US 2024/0391632 A1
(43) Pub. Date: Nov. 28, 2024

(54) LABEL DISPENSE ARRANGEMENT AND METHOD AND ASSOCIATED LABELING SYSTEM FOR ADHESIVE LABELS

(71) Applicant: ID Technology LLC, Ft. Worth, TX (US)

(72) Inventors: Mark N. BOWDEN, Nokomis, FL (US); Matthew D. McLEAN, Monkton, MD (US); Ryan COOPER, Red Lion, PA (US)

(21) Appl. No.: 18/662,191

(22) Filed: May 13, 2024

Related U.S. Application Data
(60) Provisional application No. 63/504,041, filed on May 24, 2023.

(51) Int. Cl. B65C 9/28; B65C 9/00; B65C 9/18

(52) U.S. Cl. CPC B65C 9/28; B65C 9/0006; B65C 9/1869

(57) ABSTRACT

A label applying system includes a feed path along which a label supply, having multiple labels attached to a label liner, is moved; a label applier having a forward label holding surface; and a label peel mechanism positioned along the label feed path. The label applying system further includes one or more of a fixed position label transition ramp, a label transition ramp with a portion forward of the label holding surface for label kickout and/or an air mover with focused ducting.

### TECHNICAL FIELD

The present application relates generally to label applying and, more particularly, to a label applying system for labeling items conveyed along a path.

### BACKGROUND

Material handling systems are used in many different industries and often include complex packaging and conveyor systems that convey items, such as cases (boxes) or pallets, quickly from one place to the next within a facility or multiple facilities. Labeling is often necessary to convey information about the cases so that the cases can be identified, categorized, and/or properly routed, among other reasons.

Various label applicators are known. U.S. Patent Publication No. 2023/0045251 discloses a labeling system that prints labels and feeds the labels onto an elongated flexible label applying arm that pivots back and forth between a label load position and a label apply position. An air mover is provided to create a pressure condition that retains labels on the elongated flexible label applying arm while in the label load position. In such a system, as well as other systems (both print and apply systems and systems that simply dispense and apply pre-printed labels) that feed a label onto a label applying arm, plate or pad, assuring proper label dispense and feed can be an issue.

Accordingly, it would be desirable to provide a labeling system with an improved label dispense and feed arrangement and method.

### SUMMARY

In one aspect, a label applying system includes a feed path along which a label supply, comprising multiple labels attached to a label liner, is moved. A label applier is movable between a label load position, for receiving a label, and a label apply position, the label applier having a forward label holding surface. A label peel mechanism is positioned along the label feed path. A label transition ramp is between the label peel mechanism and a location of the forward label holding surface when the label applier is in the label load position, the label transition ramp having a fixed position that does not move with the label applier such that a positional relationship between the label peel mechanism and the label transition ramp is not affected by movement of the label applier.

In another aspect, a label applying system includes a feed path along which a label supply, comprising multiple labels attached to a label liner, is moved. A label applier includes a forward label holding surface. A label peel mechanism is positioned along the label feed path, and a label transition ramp is between the label peel mechanism and a location of the forward label holding surface, wherein the label transition ramp includes a portion that is forward of the forward label holding surface as the label applier receives a label.

In a further aspect, a label applying system includes a feed path along which a label supply, comprising multiple labels attached to a label liner, is moved. A label applier is located in a label load position, for receiving a label, the label applier having a forward label holding surface. A label peel mechanism is positioned along the label feed path. An air mover is located and configured such that operation of the air mover creates a pressure condition at the forward label holding surface to pull a leading end of the label onto the forward label loading surface after the leading end moves past the label transition ramp, wherein the air mover is configured to focus a majority of air flow along an initial label load region of the label applier.

In yet another aspect, a method of loading a label onto a label applier involves: separating the label from a label liner moving along a label feed path; feeding a leading end of the label forwardly of a label transition ramp positioned between a location of separation of the label from the label liner and a forward label holding surface of the label applier; drawing the leading end of the label onto the forward label holding surface via air pulled through openings of the label applier; and levering a trailing end of the label forward of the forward label holding surface when a trailing edge of the trailing end reaches the location of separation.

In yet another aspect, a method of loading a label onto a label applier involves: separating the label from a label liner moving along a label feed path; feeding a leading end of the label forwardly of a label transition ramp positioned between a location of separation of the label from the label liner and a forward label holding surface of the label applier; drawing the leading end of the label onto the forward label holding surface via air pulled through openings of the label applier; wherein the air is pulled by an air mover that is configured to draw a primary flow of air from an initial label load region of the label applier and a secondary flow of air from areas beyond the initial label load region, the secondary flow of air being less than the primary flow of air.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1-2 are perspective views of a label applying system;

FIGS. 3-6 and 6A show views of a label applier of such as system relative to an air mover;

FIGS. 7 and 8 show perspective views of the air mover;

FIGS. 9A-9F show a sequence of label loading onto the label applier;

FIG. 10 shows an alternative arrangement of a label applier relative to the air mover;

FIGS. 11-13 show an alternative label applying system; and

FIG. 14 shows an alternative air mover configuration.

### DETAILED DESCRIPTION

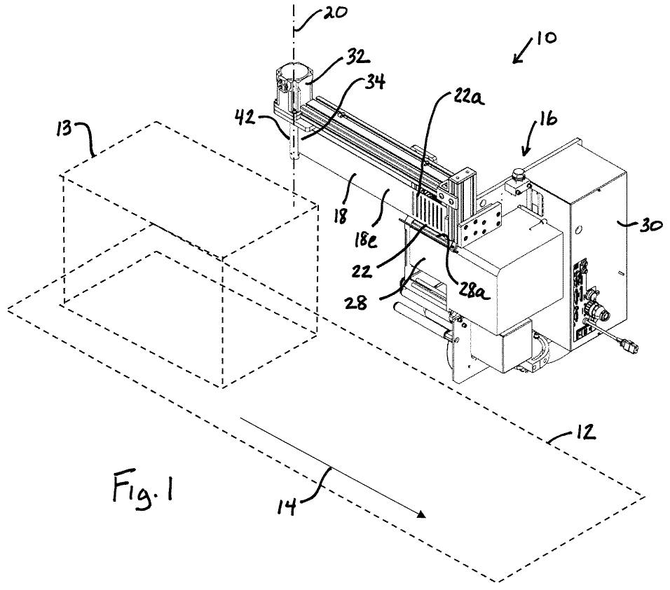

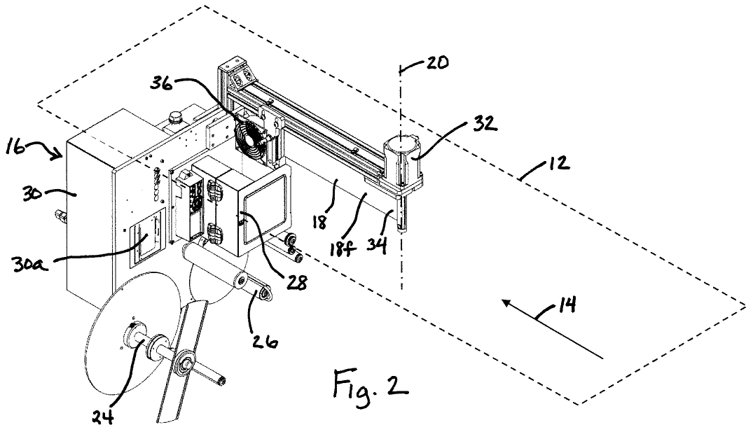

Referring to FIGS. 1-2, a label applying system 10 includes a conveyance path 12 (e.g., formed by any suitable conveyor technology, such as a roller conveyor or belt conveyor) for moving items 13, along an item conveyance path in a conveyance direction 14, and a label print and apply unit 16. Here, the label print and apply unit 16 is arranged alongside the conveyance path 12 and includes a label applying arm, here an elongated label applying arm 18, that is pivotably moveable, via rotation about a pivot axis 20, between the illustrated label load position spaced away from the item, and adjacent an air mover 36, and a label apply position in which a free end 22 of the elongated label applying arm 18 is moved away from the air mover (e.g., toward and into contact with the item).

Here, the label print and apply unit includes a support arm 24 for holding a label stock supply roll, an arm 26 for holding a label backing take-up roll, a label print unit 28 and a control system 30. The label print unit 28 includes a label output 28a positioned to feed printed labels onto a label carrying portion of the elongated label applying arm 18, which, in this case, is at the free end 22 of the elongated label applying arm. A motor 32 (e.g., a servomotor) is operatively connected to a drive end 34 of the elongated label applying arm for effecting pivot of the elongated label applying arm about the pivot axis 20. The elongated label applying arm may be configured to be sufficiently flexible such that at least the label carrying portion of the elongated label applying arm bends, including bending of the label contacting surface of the label carrying portion, as the label carrying arm moves into contact with the item, for pressing a label against the item.

Here, the free end 22 of the elongated label applying arm includes a plurality of openings 22a that pass through a thickness of the elongated label applying arm from a label carrying side 18e of the elongated label applying arm to the opposite side 18f of the elongated label applying arm. When the elongated label applying arm 18 is in the label load position of FIGS. 1 and 2, the air mover 36 (e.g., a fan unit) is associated with the free end to create a pressure drop across the elongated label applying arm, via the plurality of openings 22a, so as to draw a label onto and hold a label on the label carrying portion once the label is fed by the label print unit 28. When the elongated label applying arm moves toward the label apply position, the air mover, which does not move with the elongated label applying arm 18, is no longer associated with the free end 22.

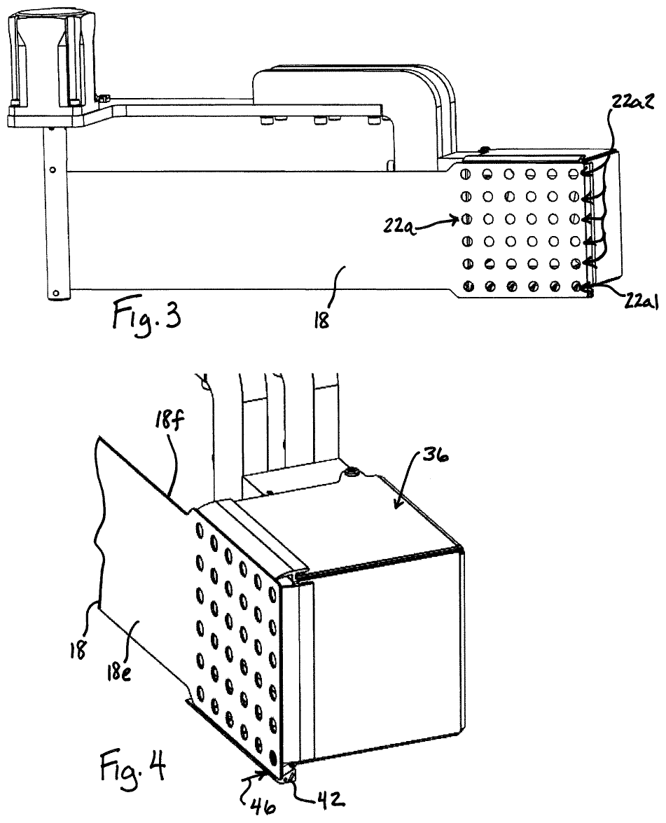

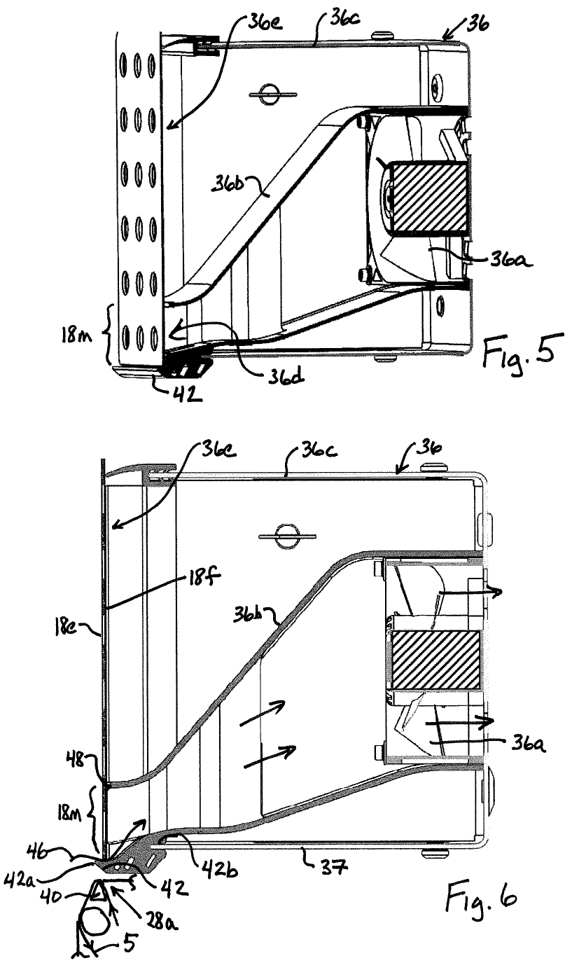

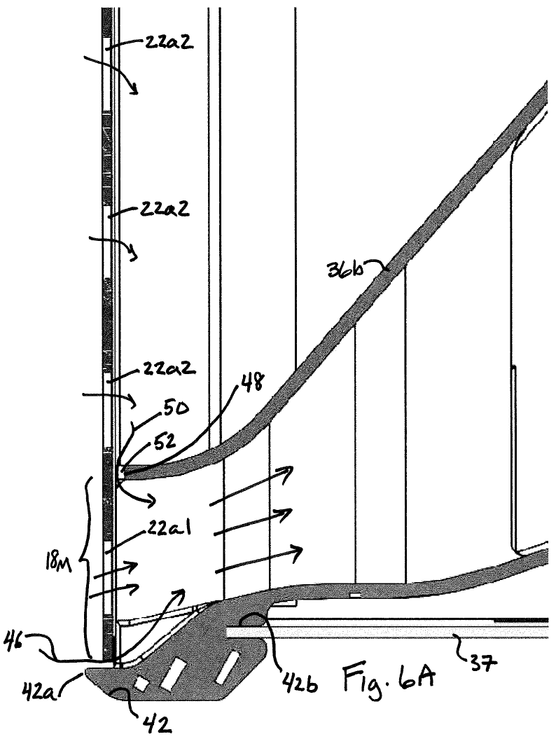

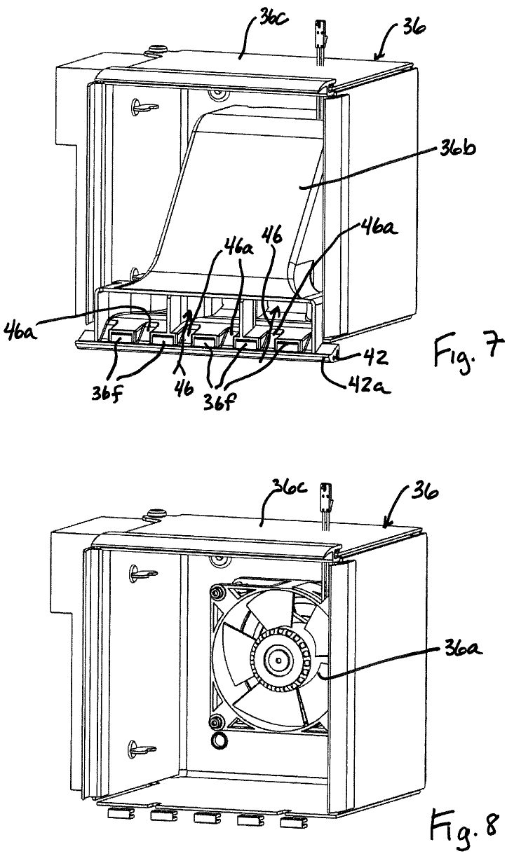

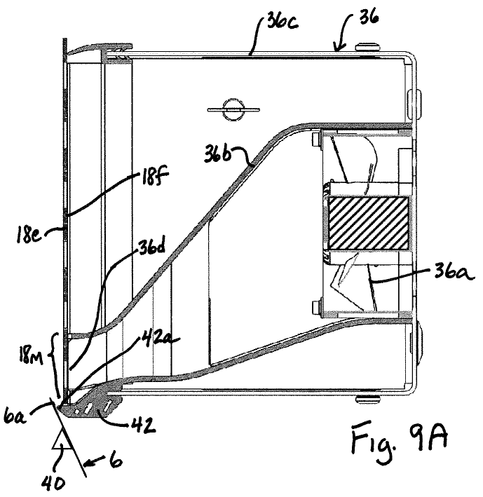

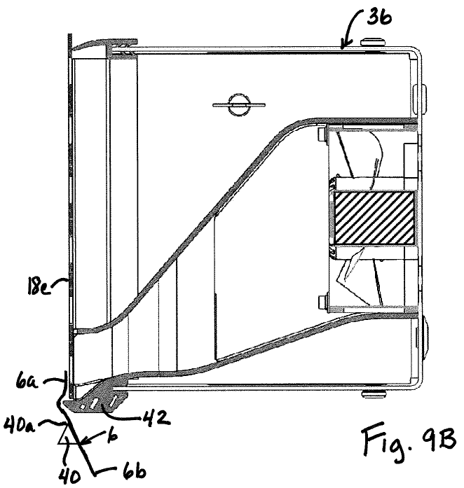

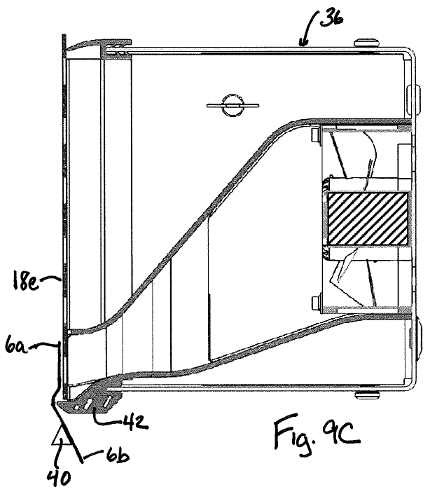

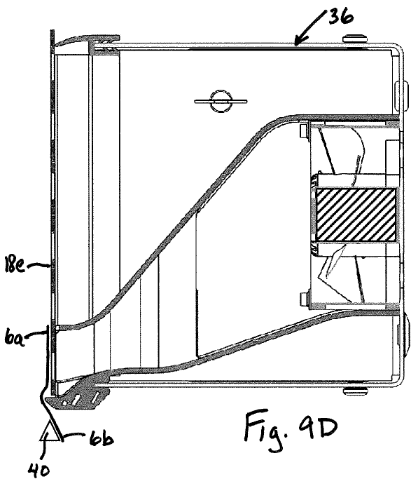

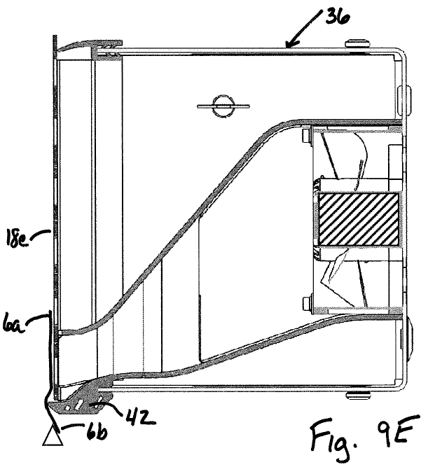

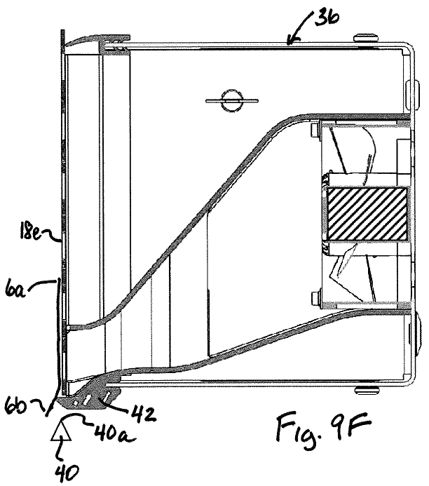

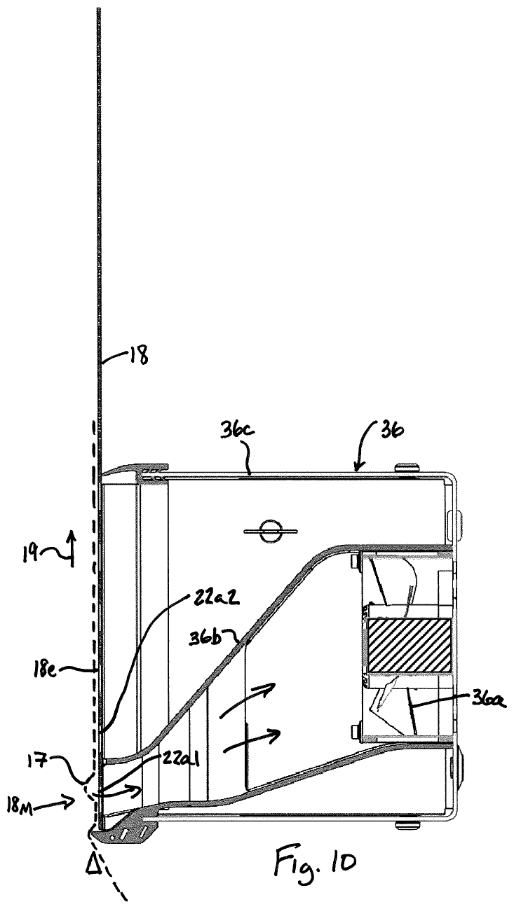

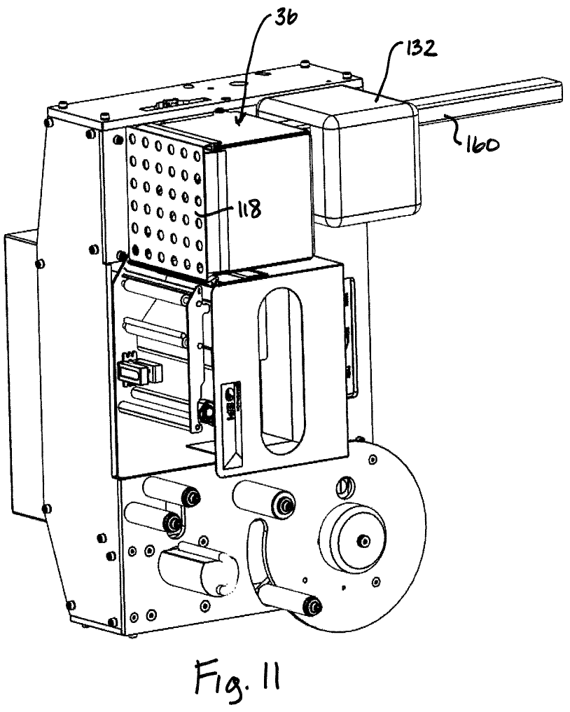

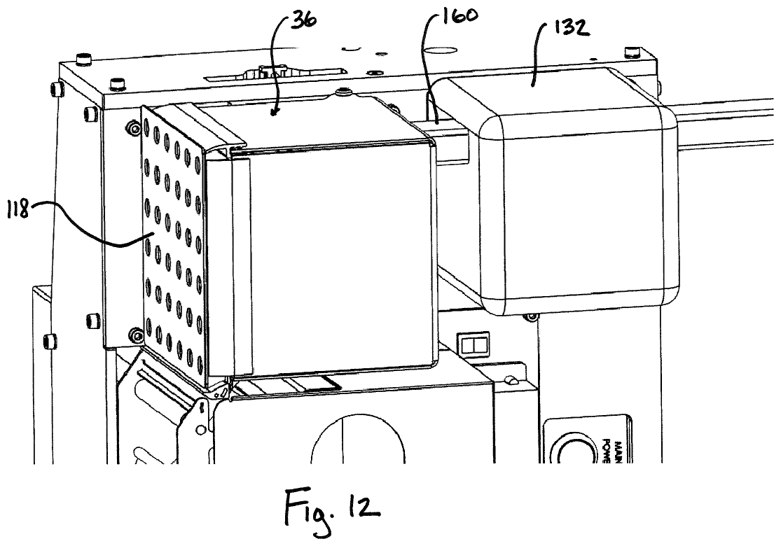

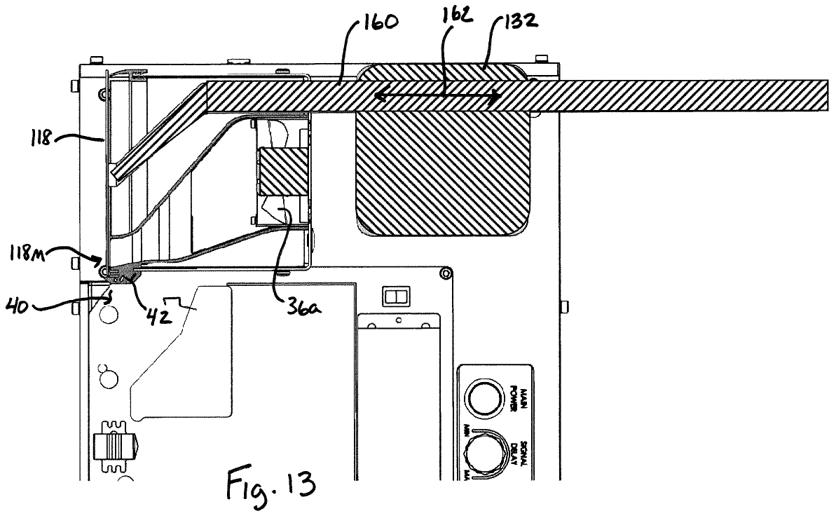

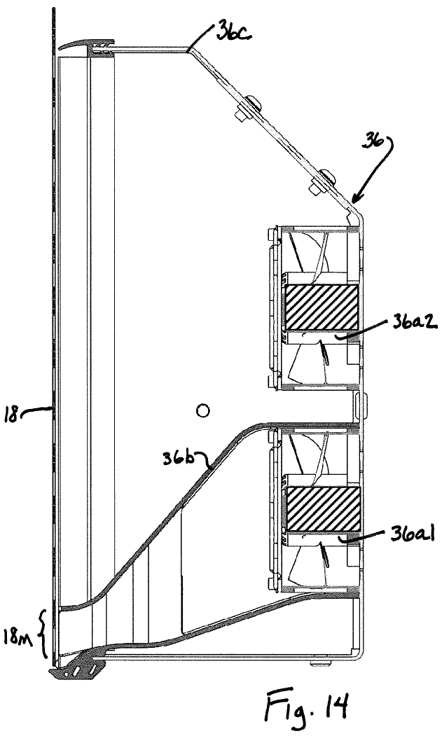

Referring to FIGS. 3-6, 6A, 7-8 and 9A-9F, the label output 28a (shown schematically in FIG. 6) includes an associated label peel mechanism 40 (e.g., a peel bar downstream of the printhead) around which the label supply (label liner 5 with multiple labels 6 thereon) moves downstream of printing such that the printed labels are peeled from the liner. A label transition ramp 42 is located between the label peel mechanism 40 and a location of the forward label holding surface 18e of the label applying arm (aka label applier), when the label applier is in the label load position. Notably, the transition ramp 42 has a fixed position that does not move with the label applier 18, such that a positional relationship between the label peel mechanism 40 and the label transition ramp 42 is not affected by movement of the label applier 18. In addition, the label transition ramp 42 includes a nose portion 42a that is forward of the forward label loading holding surface 18e, when the label applier 18 is in the label load position. As used herein the term “forward” means perpendicularly outward and away from the label holding surface or side 18e of the label applicator, which, in the illustrated embodiment, is toward the location to which the label applier will move to apply a label, and thus the surface of the label applier that receives the label is the forward label holding surface of the label applier and structures that are perpendicularly outward of the forward label holding surface or side are deemed to be positioned forward of that forward label holding surface, regardless of whether such structures are in line with the forward label holding surface.

Per FIG. 9A, a label 6 separating from the label liner departs the liner in a direction that includes a directional component that is parallel to the forward label holding surface 18c and a directional component that is perpendicular to and away from the forward label holding surface 18c. The air mover 36 is located such that operation of the air motive element (e.g., axial fan) of the air mover creates a pressure condition at the forward label holding surface 18c, when the label applier is in the label load position, to pull a leading end 6a of the label 6 onto the forward label holding surface 18e after the leading end 6a moves past the label transition ramp 42, per the sequence of FIGS. 9A-9F. This causes the label 6 to take on a curved configuration, around the label transition ramp 42, as the label moves onto the forward label holding surface 18a of the label applier. Notably, the label interacts with the nose portion 42a such that a trailing end 6b of the label is kicked forwardly of a liner turnaround edge 40a defined by the label peel mechanism as the trailing end 6b of the label reaches the liner turnaround edge 40a, per FIG. 9F. Effectively, the trailing end 6b of the label is levered away from the label liner by the interaction with the nose portion 42a of the label transition ramp 42. This feature is advantageous because it prevents the trailing edge of the label from remaining stuck on the label liner and adhered to the following label when movement of the label stock is halted, assuring that the label is separated from the label stock when the label applier acts to move the label to the product. This separation is important for successful application of labels, and greater separation is advantageous when using more aggressive label adhesives, lower quality labels and/or higher weight adhesive coatings, to assure that the label will not be pulled away from the label applier when the label applier moves to apply the label, and reducing the likelihood of a label jam. In print and apply systems like the exemplary embodiment, if the trailing edge of the dispensed label remains on the label liner, when the label liner is fed backward to position the following label for printing, the only partly dispensed label may be undesirably pulled back into the printer. Thus, the described feature that kicks the trailing end edge of the label away from the label liner also avoids this problem.

The air mover 36 includes a fan 36a, a primary duct housing 36b and a secondary duct housing 36c, wherein the primary duct housing 36b is disposed within the secondary duct housing 36c. The fan 36a draws air flow 44 through the primary duct housing 36b, via an air inlet opening 36d of the primary duct housing. As shown, when the label applier 18 is in the label load position, the air inlet opening 36d is located only along an initial label load region 18m of the label applier 18 that is adjacent to the label transition ramp 42. Here, the label transition ramp 42 is formed as an integral part of the primary duct housing 36b (e.g., formed as a monolithic molded part therewith).

The secondary duct housing 36b defines an air inlet opening 36e that, when the label applier is in the label load position, extends along portions of the label applier 18 that are beyond the initial label load region 18m. The duct housing structures are also configured such that at least some air is pulled by the air mover along a flow path 46 between the ramp facing edge of the label applier and the label transition ramp 42 (e.g., along channel regions 46a).

Here, the label transition ramp 42 of the primary duct housing 36b includes a rearward facing slot 42b that engages (e.g., frictionally) with a forward edge of a bottom wall 37 of the secondary duct hosing 36c to position the two housings with respect to each other.

When the label applier 14 is in the label load position, a rear surface 18f of the label applier is at least partly spaced away from a forward edge 48 of part of the air inlet opening 36d of the primary duct housing such that operation of the fan draws at least some air along a flow path 50 from within the secondary duct housing 36c, along a gap 52 between the rear surface 18f and the edge 48, and then into the air inlet opening 36d of the primary duct housing 36b. In embodiments, a size of the gap 52 is between 0.5 mm and 6 mm (such as between 1 mm and 4 mm), but other variations are possible. In the illustrated embodiment, a set of lower bumpers 36f are provided to aid in holding the label applier away from the edge 48 to maintain the air flow gap 52. These bumpers also work to absorb the return impact of the label applier, and may be formed of a shock-absorbing material for this purpose.

This overall configuration of the primary and secondary duct housings assures that, when there is no label on the label applier, a majority of air drawn by operation of the fan 36a of the air mover is pulled through a first set 22al of the through openings 22a, which first set 22al is located along the initial label load region, which is adjacent to the label transition ramp 42, as well as the flow path 46, so as to more quickly draw the label against the label applier as the label is separated from the label liner. Air is also pulled through the remaining sets 22a2 of the through openings 22a located on portions of the label applier beyond the region 18m, due to the flow path 50, but to a much lesser extent. By way of example, a total air flow through the through openings of the first set 22al may be at least two times greater (such as three times greater) than the total air flow through the through openings of the remaining sets 22cl, and when the first set 22al of through openings become covered by a label, the total air flow through the through openings of the remaining sets 22cl increases by at least 50% (such as at least 100%).

In the illustrated embodiment, the first set 22al of through openings is defined by a single row of openings that runs adjacent to and along an edge of the label applier that is adjacent the label transition ramp. However, in other variations, the first set of openings 22al could be made up by more than one row, or by some other pattern of openings, in either case where those openings are located on the initial label load region 18m of the label applier. In the illustrated embodiment, the air inlet opening 36e of the secondary duct housing 36c defines a flow area that is at least twice as large, and preferably at least three times as large, as a flow area defined by the air inlet opening 36d of the primary duct housing 36. However, variations are possible.

Alternative configurations are possible. For example, referring to FIG. 10, an embodiment in which the label applier 18 extends beyond the air mover 36 in the label load direction 19 is shown. This arrangement can be particularly useful for applying longer labels, such as eight to sixteen inches, but can also be used for shorter label lengths, such as one inch and above. In this regard, the focused air pull provided by the primary duct housing 36b in the initial label load region 18m of the label applier aids in preventing longer labels from inchworming. Inchworming is the situation in which the label pulls away from the forward label holding surface 18e as the label is being pushed along the label holding surface, and tends to occur in the initial load region of the label applier with longer labels due to increased frictional resistance to pushing of the label as more of the label contacts the label holding surface 18e. If inchworming occurs, the label will not continue to progress properly along the label holding surface 18c. With the described ducting of the air mover 36, if the label starts to inchworm away from the label holding surface 18e in initial label load region 18m (e.g., as suggested by label bumpout region 17 in FIG. 10), the first set 22al of the through openings of the label applier will become uncovered, allowing the primary duct housing 36b to refocus a majority of the drawn air flow back to the first set 22al of openings, thereby pulling the label back onto the label holding surface 18e and eliminating the inchworm.

Advantageously, the above-described systems can be used for smaller labels (e.g., 2″×2″) and larger labels (e.g., 6″×12″) without requiring any tooling or mechanical changes to the label applier, other than a label supply change if needed.

The above-described label applier includes a number of unique features, which are all used together, but which can each be used separately in other embodiments.

### (1) Fixed Position Transition Ramp

A first unique and advantageous feature is the fixed position of the label transition ramp 42, such that the label transition ramp does not move with the label applier 18 when the label applier is applying the label. Thus, the relative position between the label peel mechanism or label peel location and the label transition ramp is, effectively, permanently set, because the label peel mechanism or label peel location also does not move. The main advantage of this fixed relative positioning is repeatability in dispense performance. The relationship between the peel bar, and the transition ramp impacts performance. When the transition ramp is part of the moving applicator device, due to machine tolerances and potential variances in the position of the moving applicator device, the relative positioning between the label transition ramp and the dispensing location (e.g., the point where the label peels from the label liner) varies as the device is running, leading to varied performance of the label dispense. When the position of the label transition ramp is fixed relative to the label dispense location, the variation in position of the applicator device, which is less critical, does not impact the relative positioning between the label dispense location and label transition ramp. Another advantage is that the label dispense operation may, in some cases, be started sooner, as a typical moving transition ramp needs to settle into position before accepting a label, which can take some time due to inherent flutter/shaking when the label applicator returns to the label load position. With the fixed transition ramp, label dispense can begin as soon as the applicator device has returned, without needing to wait for settling and/or vibrations to dampen.

### (2) Label Transition Ramp Forward of the Label Holding Surface for Label Kickout

A second unique feature is positioning of the label transition ramp 42 such that at least part of the label transition ramp 42 is located forward of the label holding surface 18c (when the label applier is in the label load position). This feature provides the levering action to shift or kick the trailing end of the label, away from the peel location and off of the label liner, when the trailing edge of the label reaches the peel location. As noted above, the advantage of this feature includes preventing the trailing edge of the label from remaining stuck on the label liner and adhered to the following label when movement of the label stock is halted, assuring that the label is separated from the label stock when the label applier acts to move the label to the product, and preventing the dispensed label from being undesirably pulled back into the printer if the direction of the label liner is reversed in order to reposition the immediately following label for printing. This feature could also be implemented in embodiments in which the label transition ramp moves with a moving label applier.

(3) Air Mover with Focused Ducting

A third unique and advantageous feature is the configuration of the ducting of the air mover 36 such that a majority of the air flow is, at least initially, pulled through openings on the label applier that are located on an initial label load region 18m of the label applier and, in some cases, along a flow path between an edge of the label applier and the label transition ramp. This feature (i) helps assure quick pulling of the dispensing label onto the label holding surface of the label applier, (ii) reduces the likelihood of inchworming of the label and/or (iii) aids in assuring that a given label applier can be used with a variety of label sizes.

As mentioned, the three features can all be used together, as shown above. However, each of the features could be implemented, without the other two features, to provide an improved label applier/label applying system.

Notably, although the above-described embodiments contemplate the use of a pivoting label applier which, in some cases may be a flexible arm, each of the three features can be used in other label appliers. By way of example, referring now to the embodiment of FIGS. 11-13, a labeling system using a label applier 118 in the form of a linearly movable pad or plate is shown. The label applier 118 is driven linearly, per arrow 162, by a prime mover 132 that applies a linear movement action to an arm 160 that connects to the back side of the label applier 118. The air mover 36, with fan 36a, primary duct housing 36b and secondary duct housing 36c is configured as described above to focus a primary air flow through openings in the initial label load region 118m of the label applier 118. The label transition ramp 42 is also fixed relative to the moving label applier, and the label transition ramp 42 is configured with a nose portion forward of the label holding surface of the label applier to provide the kickout of the trailing end edge of a label.

In some embodiments, the three features, together or individually, could be implemented as to labeling systems in which pre-printed labels are loaded onto the label applier.

Moreover, the label kickout feature and focused ducting of the air mover, with associated label load functionality and operation, could be implemented as to labeling systems in which the label applier remains stationary (e.g., always in the label load position), with the label being blown off of the label applier and onto an item, or in situations in which the label applier is a label belt that carries the label in a direction parallel to the forward label holding surface of the label applier.

Although the above embodiments show an air mover with a single fan to achieve the desired focused air flow, in another embodiment, per FIG. 14, the air mover 36 includes a primary duct housing 36b with its own fan 36al, and a secondary duct housing 36c with its own fan 36a2. In some cases, a single fan may not create a sufficient pressure drop to hold the label on the on the label applier. In these instances, multiple fans may be used to create an optimal pressure drop, often divided by the duct housing as in the case of FIG. 14. In other situations, multiple fans may enable simplification of the primary and/or secondary duct housing structures.

Still other modifications and variations are also possible.

1. A label applying system, comprising:
a feed path along which a label supply, comprising multiple labels attached to a label liner, is moved;
a label applier movable between a label load position, for receiving a label, and a label apply position, the label applier having a forward label holding surface;
a label peel mechanism positioned along the label feed path;
a label transition ramp between the label peel mechanism and a location of the forward label holding surface when the label applier is in the label load position, the label transition ramp having a fixed position that does not move with the label applier such that a positional relationship between the label peel mechanism and the label transition ramp is not affected by movement of the label applier.

2. The label applying system of claim 1, wherein the label applier is linearly movable for applying labels or the label applier is pivotably movable for applying labels.

3. The label applying system of claim 1, further comprising an air mover with a duct housing, wherein the label transition ramp is fixed on the duct housing.

4. The label applying system of claim 1, wherein the label transition ramp includes a nose portion that is forward of the forward label holding surface, when the label applier is in the label load position.

5. The label applying system of claim 4, further comprising:
an air mover located such that operation of the air mover creates a pressure condition at the forward label holding surface, when the label applier is in the label load position, to pull a leading end of the label onto the forward label loading surface after the leading end moves past the label transition ramp, such that the label turns around the nose portion of the label transition ramp, as the label moves onto the forward label holding surface, such that a trailing end of the label is kicked forwardly of a liner turnaround edge defined by the label peel mechanism as the trailing end of the label reaches the label turnaround edge.

6. The label applying system of claim 1, further comprising:
an air mover located such that operation of the air mover creates a pressure condition at the forward label holding surface, when the label applier is in the label load position, to pull a leading end of the label onto the forward label loading surface after the leading end moves past the label transition ramp, wherein the air mover is configured such that at least some air is pulled by the air mover along a flow path between the label applier and the label transition ramp.

7. The label applying system of claim 1, further comprising:
an air mover located such that operation of the air mover creates a pressure condition at the forward label holding surface, when the label applier is in the label load position, to pull a leading end of the label onto the forward label loading surface after the leading end moves past the label transition ramp, wherein the air mover includes a primary duct housing and a secondary duct housing, wherein the primary duct housing includes an air inlet opening, wherein, when the label applier is in the label load position, the air inlet opening is located along an initial label load region of the label applier that is adjacent to the label transition ramp, and the secondary duct housing defines an air inlet opening that, when the label applier is in the label load position, extends along portions of the label applier beyond the initial label load region.

8. The label applying system of claim 7, wherein, when the label applier is in the label load position a rear surface of the label applier is at least partly spaced away from an edge portion of the air inlet opening of the primary duct housing such that operation of the air mover draws at least some air along a path from within the secondary duct housing, along a gap between the rear surface and the edge portion and then into the air inlet opening of the primary duct housing.

9. A label applying system, comprising:
a feed path along which a label supply, comprising multiple labels attached to a label liner, is moved;
a label applier having a forward label holding surface;
a label peel mechanism positioned along the label feed path;
a label transition ramp between the label peel mechanism and a location of the forward label holding surface, wherein the label transition ramp includes a portion that is forward of the forward label holding surface as the label applier receives a label.

10. The label applying system of claim 9, further comprising:
an air mover located such that operation of the air mover creates a pressure condition at the forward label holding surface to pull a leading end of the label onto the forward label loading surface after the leading end moves past the label transition ramp, such that a trailing end of the label is kicked forwardly of a liner turnaround edge defined by the label peel mechanism as the trailing end of the label reaches the label turnaround edge.

11. The label applying system of claim 9, wherein (i) the label applier is a moving label applier that moves between a label load position and a label apply position or (ii) the label applier is a stationary label applier.

12. The label applying system of claim 9, further comprising:
an air mover located such that operation of the air mover creates a pressure condition at the forward label holding surface to pull a leading end of the label onto the forward label loading surface after the leading end moves past the label transition ramp, wherein the air mover includes a primary duct housing and a secondary duct housing, wherein the primary duct housing includes an air inlet opening that is located along an initial label load region of the label applier that is adjacent to the label transition ramp, and the secondary duct housing defines an air inlet opening that extends along portions of the label applier beyond the region.

13. A label applying system, comprising:
a feed path along which a label supply, comprising multiple labels attached to a label liner, is moved;
a label applier located in a label load position, for receiving a label, the label applier having a forward label holding surface;
a label peel mechanism positioned along the label feed path;
an air mover located and configured such that operation of the air mover creates a pressure condition at the forward label holding surface to pull a leading end of the label onto the forward label loading surface after the leading end moves past the label transition ramp, wherein the air mover is configured to focus a majority of air flow along an initial label load region of the label applier.

14. The label applier of claim 13, wherein the air mover includes a primary duct housing and a secondary duct housing, wherein the primary duct housing includes an air inlet opening that is located along the initial label load region of the label applier, and the secondary duct housing defines an air inlet opening that extends along portions of the label applier beyond the initial label load region.

15. The label applying system of claim 14, wherein, with the label applier is in the label load position, a rear surface of the label applier is at least partly spaced away from an edge portion of the air inlet opening of the primary duct housing such that operation of the air mover draws at least some air along a path from within the secondary duct housing, along a gap between the rear surface and the edge and then into the air inlet opening of the primary duct housing.

16. The label applying system of claim 14, wherein the air inlet opening of the secondary duct housing defines a flow area that is at least twice as large as a flow area defined by the air inlet opening of the primary duct housing.

17. The label applying system of claim 14, wherein the label applier includes a plurality of through openings, wherein, the primary duct housing and the secondary duct housing are configured such that, with the label applier is in the label load position and no label loading onto the label applier, operation of the air mover pulls a primary flow of air through a first set of the plurality of through openings, located along the initial label load region, and a secondary flow of air from a second set of the plurality of through openings, located along the portions of the label applier beyond the initial label load region, the secondary flow of air being less than the primary flow of air.

18. The label applying system of claim 17, wherein, when no label is on the forward label holding surface, a total air flow through the through openings of the first set of the plurality of through openings is at least two times greater than a total air flow through the the second set of the plurality of through openings.

19. The label applying system of claim 18, wherein, when the first set of the plurality of through openings become covered by a label, the total air flow through the through the second set of the plurality of through openings increases by at least 50%.

20. The label applying system of claim 14, wherein the air mover includes a first fan positioned to draw air primarily through the inlet opening of the primary duct housing and a second fan positioned to draw air primarily through the inlet opening of the secondary duct housing.

21. The label applying apparatus of claim 13, wherein the label applier is movable from the label load position forward and toward a label apply position.

22. A method of loading a label onto a label applier, the method comprising:
separating the label from a label liner moving along a label feed path;
feeding a leading end of the label forwardly of a label transition ramp positioned between a location of separation of the label from the label liner and a forward label holding surface of the label applier;
drawing the leading end of the label onto the forward label holding surface via air pulled through openings of the label applier;
levering a trailing end of the label forward of the forward label holding surface when a trailing edge of the trailing end reaches the location of separation.

23. The method of claim 22 wherein the levering results, at least in part, from the label moving over a nose portion of the label transition ramp, which nose portion is located forwardly of the forward label holding surface.

24. A method of loading a label onto a label applier, the method comprising:
separating the label from a label liner moving along a label feed path;
feeding a leading end of the label forwardly of a label transition ramp positioned between a location of separation of the label from the label liner and a forward label holding surface of the label applier;
drawing the leading end of the label onto the forward label holding surface via air pulled through openings of the label applier;
wherein the air is pulled by an air mover that is configured to draw a primary flow of air from an initial label load region of the label applier and a secondary flow of air from areas beyond the initial label load region, the secondary flow of air being less than the primary flow of air.
